(19) United States
(12) Patent Application Publication
(10) Pub. No.: US 2012/0062911 A1
(43) Pub. Date: Mar. 15, 2012

(54) METHOD FOR SCHEDULING COLOR PRINT JOBS ON A NETWORK OF CONFIGURABLE COLOR PRINTERS

(75) Inventor: David C. Robinson, Penfield, NY (US)

(73) Assignee: Xerox Corporation, Norwalk, CT (US)

(21) Appl. No.: 12/880,317

(22) Filed: Sep. 13, 2010

(51) Int. Cl. H04N 1/60

(52) U.S. Cl. 358/1.9

(57) ABSTRACT

A method to schedule color print jobs to one or more configurable color printers is described. The method monitors the state of any printers in use and maintains a queue of print jobs. The print jobs are assigned priorities based on a set of system policies.

### BACKGROUND

Modern color printers are being made with more than the standard four CMYK colorants. These extra colorants are used to extend the gamut of the printer or to provide the ability to print a specific color directly instead of reproducing the color by a CMYK combination. It is becoming common to find printers that have additional colorants; furthermore there are printers where the additional colorants are not a fixed set, but rather include an expanded set of colorants some small number of which may be attached to the printer at any time.

Having replaceable colorants allows printing of specialized colors to an exacting specification. An example of such a specialized color is printing of a corporate logo in a very specific color, e.g. Pantone 32.

When a print establishment has one or more configurable color printers each job would require installing the set of configurable colorants needed for the job. When the establishment has a stream of jobs arriving for printing, a significant amount of time can be lost due to the overhead associated with changing the colorants. This overhead could be reduced by scheduling the jobs so that jobs with similar colorant requirements are processed together, thus reducing the overhead associated with changing colorants.

Therefore, it would be desirable to have a way to schedule print jobs to one or more configurable color printers in a way that provides optimal use of the printers. Such an optimal use may include maximizing the number of pages printed in a given time or perhaps maximizing the profit realized from the printing, or some other criterion.

### BRIEF DESCRIPTION OF THE DRAWING

The drawings are only for purposes of illustrating various embodiments and are not to be construed as limiting, wherein:

FIG. 1 illustrates a method for scheduling print jobs for a set of configurable color printers;

FIG. 2 illustrates a method for assigning a color print job to one of a plurality of printers;

FIG. 3 shows an exemplary embodiment of a system to schedule print jobs for a set of configurable color printers.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts could be properly illustrated.

The description that follows describes a situation where color print jobs have been submitted to a printing facility. The printing facility has more than one color printer with one or more changeable colorants. These changeable colorants are in addition to the standard CMYK colorant set that is characteristic of color printers. The changeable colorants may be chosen from a predefined set, or it may be possible that the changeable colorants can be customized for particular printing applications.

Some of the color print jobs that are submitted to the facility will have requirements to use one or more of the changeable colorants to properly print the job. It is likely that when a new color print job arrives at the facility that none of the printers will have installed exactly the set of colorants that are needed for the job.

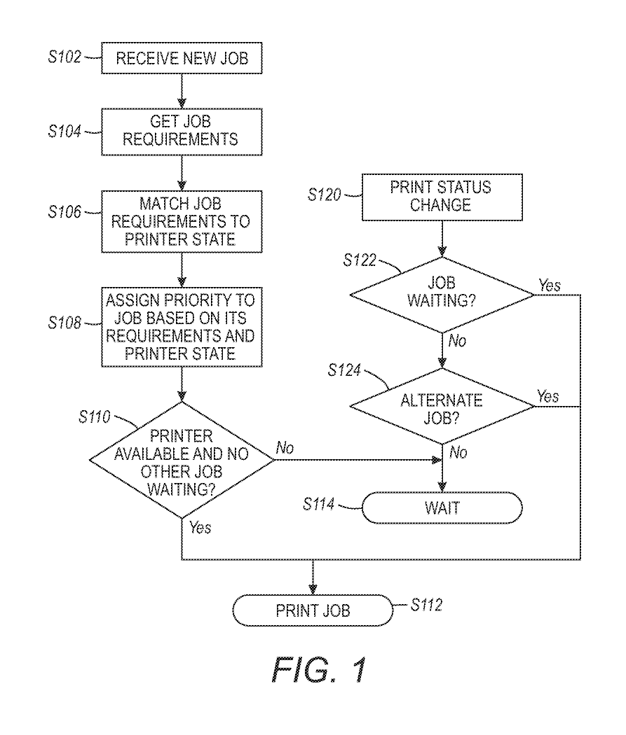

When jobs are simply scheduled in the order of arrival it is likely that a significant amount of time will be lost to the overhead associated with changing the colorants. FIG. 1 shows a method of scheduling print jobs that makes improved use of the facility.

The method can be invoked in one of two ways. In S102, a new print job is received. The job will include information about any special colorant requirements beyond the standard CMYK set. The job may also include information pertaining to other requirements such as special media or perhaps identifying high priority or time limits. These requirements are identified in S104; in particular the colorant requirements are extracted.

In S106, the job requirements are match to the current state of the printers currently in operation. The match compares the colorant requirements of the print job to the colorant or colorants currently mounted on each printer in the facility. The match may reveal that one or more of the printers currently have the exact set of colorants needed by the print job. This exact match may also include a case where the print job colorant requirements match a subset of the colorants mounted on one of the printers.

In S108, the results of the matching process, from S106, are used to assign a priority to the job. This priority would take into account the overhead that may be needed to change the colorants on any of the printers. The priority may further include other factors that are commonly used in print scheduling such as time constraints, requirements for special media or similar needs.

In S110, a check is made to see if there is a printer available to meet the jobs requirements. This check would also include comparing the priority of the current job to the priority of jobs that have been previously submitted to the print facility but have not yet been printed.

When the result of the check, in S110, indicates that a printer is available and that the new job has a higher priority than any previously submitted job that is awaiting printing the job is submitted for printing in S112.

When no printer is available or when there are other jobs waiting with higher priority the job is held in a queue for later printing in S114.

The method of FIG. 1 may also be invoked by a change in the status of one of the printers in the print facility at S120. Such a change may include a printer finishing printing a previously submitted job. Another change may include an indication that an idle printer has had the changeable colorants mounted on it changed. A change in printer status may also indicate that an action is needed that would make the printer unavailable for printing.

When the change of printer status indicates that a printer is now free for a new job, a check is made, at S122, to see if there is a job being held for printing that matches the printer. Such a job may have been previously scheduled for the particular printer, in anticipation of completion of another job, or the job may be held for the first available printer. When such a job is available, the method continues, at S112, where the job is printed.

When there is no job identified in S122, a check is made to see if there is some other job that is being held that could be rescheduled for the newly idled printer. When such a job exists the alternate job is submitted for printing at S112. When no alternate job is available the method simple waits at S114 for either a new job to arrive or for another printer to become available.

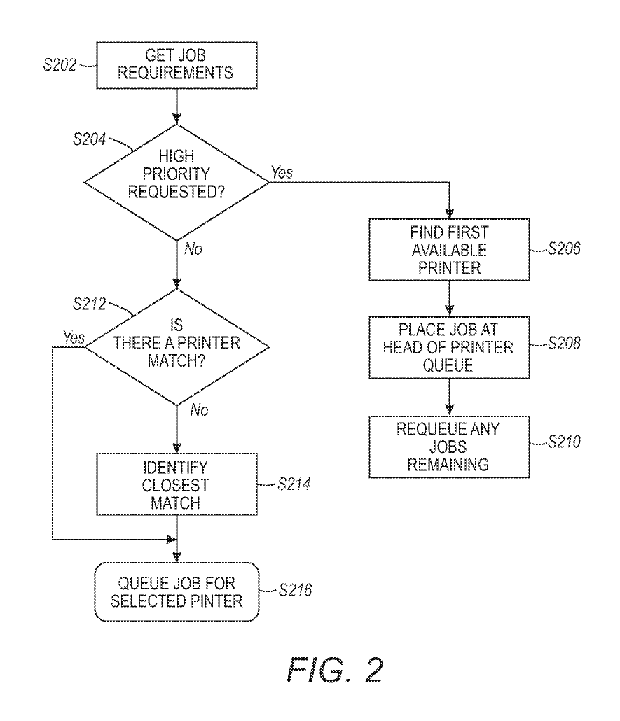

FIG. 2 shows an exemplary method for assigning a priority to a color print job corresponding to S108 of FIG. 1. The method may be invoked whenever a new print job is submitted. The method of FIG. 2 assumes that there is either a separate queue for each printer in the print facility or else there is a single queue with information attached to each job in the queue that identifies a particular printer that the job may be assigned to.

The method begins at S202 where the requirements, in particular, the color requirements of the newly submitted job are extracted from the job control information that is a normal part of a print job. These requirements would identify any special colors to be used for printing the job, beyond the standard CMYK.

In S204, a check is made to identify that a possible high priority request is associated with the print job. Such a high priority request could identify a job that is to be placed at the head of the print queue. In the exemplary embodiment of FIG. 2 it is assumed that a high priority request simply means that the job should be printed immediately, that is, as soon as any printer is available. In alternative embodiments a priority request may have multiple levels associated with it so that the job would be placed in the print queue ahead of any jobs with a lower priority but not necessarily at the head of the queue.

When a high priority is associated with the print job in S206 a printer is identified to print the job. The identification of the printer may include selecting the first available printer. When there is an idle printer it is selected. When all printers are busy the first printer that will be available is identified. When there are other high priority jobs already queued for printing the current job is either assigned to the first printer that is not already committed to a high priority print job, or the current job is appended to the print queue of the first printer that will be available when other, previously submitted, print jobs complete printing. Alternatively, a comparison between two high priority print jobs can be made to further rank the two jobs.

In S208, the job is assigned to the printer identified in S206. However, by placing the new, high priority print job at the head of the queue, any jobs that are currently in the queue would be displaced. Therefore in S210 any jobs that were in the print queue are re-examined and re-queued, possibly on a different printer.

When the priority check in S204 does not identify a high priority printing request in S212 a comparison is made between the color requirements of the new job and the current set of printer configurations. When a printer configuration matches the color requirements of the newly submitted job the job is queued for printing at such a printer in S216.

When no current printer configuration matches the requirements of the newly submitted job, in S214 a search is made for the printer that most closely matches the job requirements. Such a search may identify a printer where some of the currently mounted extra colors match a subset of the job requirements. When such a printer is found, the job is preferentially attached to the queue for that printer, since the overhead associated with changing the extra colors will be smaller since there are fewer colors to change.

When none of the printers meet the requirements alternative criteria are used to match the newly submitted job to a printer. These alternative criteria may include identifying the first printer to become idle. Another alternative may identify a printer that would maximize the overall output of the print facility over some predefined period of time. Another alternative would be to identify a printer that would maximize the profit made by the print facility over some predefined period of time.

Other criteria may be used to match the job to a printer. For example the job may be assigned to a printer with a lower priority than other jobs currently assigned to the printer but with a requirement that the job not be held for more than a certain amount of time. Another criterion may be to assign a job to a printer but have the job held until after a predefined time.

After a printer has been identified in S214 the job is assigned to the queue for the identified printer in S216.

The prioritization process of FIG. 2 is only one example of how jobs may be matched to printers. Other prioritization methods may be employed, for example by assigning multiple levels of priority to jobs and then ordering the jobs in the print queue of each printer in priority order. Other examples are well known to the art.

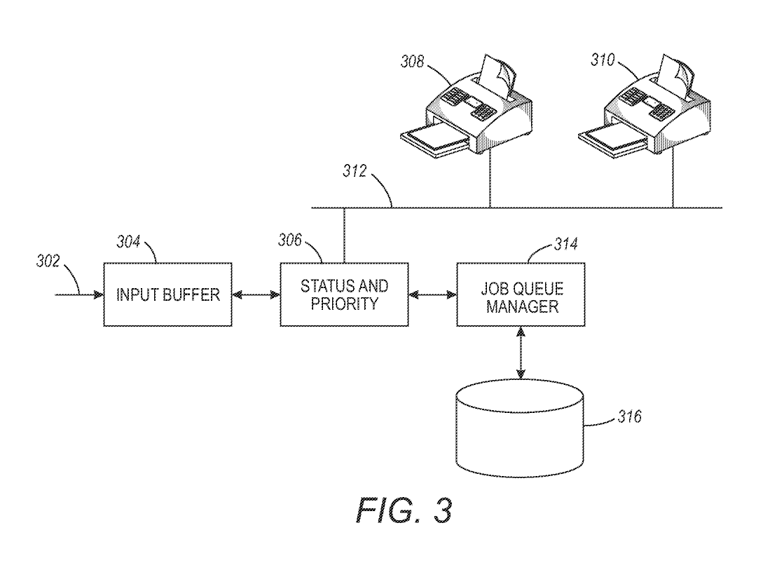

FIG. 3 shows an exemplary embodiment of a system for scheduling print jobs to configurable color printers. The system includes a plurality of configurable color printers 308 and 310.

The configurability may include one or more replaceable color housings where the replaceable color housings can be used to add additional colors beyond the standard CMYK colorants. The additional colors may include specifically formulated spot colors, or the additional colors may include colors that extend the gamut of the CMYK colorants. Other possibilities will be understood by those skilled in the art.

Alternatively, the configurable property may include, either alone or in addition to the color housings, the presence of specialized printing media.

The system receives print jobs through interface 302. Interface 302 may be a network communication port, or some other computer communications medium. Alternatively, interface 302 may be a port to allow interfacing with a mountable storage device; e.g. a flash drive; that contains the print job. The inputted print jobs are received by an input buffer 304 that holds incoming jobs until the incoming jobs can be processed by the system. Another possible function of the input buffer 304 would be to communicate the status of previously submitted print jobs to users.

A status and priority module 306 communicates with the printers 308 and 310, via a network 312. The status information includes the current state of the printer and the identification of the mounted color housings or the presence of any specialized printing media or other configurable parameters. In addition, the status may include more typical status information like the current state of the printer with regard to printing. This state may include not only an idle or busy indication but also an estimate of the time to completion of any current job being printed.

As a job is received, the job requirements are extracted from the job by the input buffer 304. These requirements include any custom colors that need to be included by mounting a replaceable color housing containing the custom color. The requirements may also include the installation of particular specialized printing media in the printer. The job requirements are transmitted to the status and priority module 306.

The status and priority module 306 compares the job requirements to the status of the printers (308 and 310) currently operating. The status and priority module 306 attempts to find a printer that matches the job requirements. When no such printer is available, the status and priority module 306 identifies a printer that can be modified to meet the requirements of the job.

The status and priority module 306 may use a method such as shown in FIG. 2 to assign a job to a printer. After assigning the job to the printer, the status and priority module 306 assigns a priority to the job. Depending on the specific policies in place in the facility, the job can be given a priority that ranks it compared to other jobs that may be assigned to the same printer.

Once a printer and priority have been assigned to a job, the job is transferred to the job queue manager 314. The job queue manager 314 stores the job on a storage medium 316, such as a disk drive. The job queue manager 314 is notified of any status changes in the printers attached to the system and when a printer becomes available, the job queue manager 314 transfers the job to the printer. The transfer process may include instructions to an operator to change the configurable print housings or to mount specialized printing media.

While the exemplary embodiment of FIG. 3 has shown separate components performing the several functions, those skilled in the art will recognize that some or all of the components of FIG. 3 could be implemented as software operating in conjunction with hardware and/or specialized hardware components of a computing system.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of scheduling color print jobs to a plurality of configurable color printers comprising:
receiving, from a plurality of configurable color printers, the status of each configurable color printer, the status including a current color configuration of the configurable color printer and a current state of any print jobs scheduled for the configurable color printer;
comparing configurable color needs of a to be scheduled color print job and the status of the plurality of configurable color printers;
assigning a priority to the color print job based on the results of the comparison and a predetermined system policy;
maintaining a queue of jobs;
ordering the jobs in the queue according to the assigned priority of the jobs; and
printing the jobs in the queue as configurable color printers become available.

2. The method of claim 1 wherein a configurable characteristic of the color printers comprises one changeable color print housing.

3. The method of claim 1 wherein a configurable characteristic of the color printers comprises the presence in the printer of specialized recording media.

4. The method of claim 1 wherein a configurable characteristic of the color printers comprises the availability of specialized recording media.

5. The method of claim 1 wherein the predetermined policy comprises assigning a high priority to any color print job whose color configuration requirements match the current configuration of one of the plurality of printers.

6. The method of claim 1 wherein the predetermined policy comprises scheduling a color print job to the next available printer.

7. The method of claim 1 wherein the predetermined policy comprises holding a print job for no more than a predetermined maximum amount of time before submitting it for printing.

8. The method of claim 1 wherein the predetermined policy comprises assigning a priority based on the profit from printing the color print job.

9. The method of claim 1 wherein the predetermined policy comprises assigning a priority based on a priority associated with the color print job.

10. A system for scheduling print jobs to a plurality of printers comprising:
a plurality of color printers, each color printer including one configurable colorant;
a job server, operatively connected to said plurality of color printers, to receive status information from each printer, the status information including identification of the replaceable colorant currently installed in the printer and a current operating state of the printer;
a source of print jobs, operatively connected to said job server, each print job containing requirements of the print job, a first requirement being information identifying replaceable colors required to print the job; and
a scheduling module, operatively connected to said job server, to maintain a queue of print jobs, the queue being ordered according to the status information from the printers and the first requirement identifying replaceable colors required to print the job.

11. The system of claim 10 wherein said scheduling module schedules print jobs according to the length of the print job.

12. The system of claim 10 wherein said scheduling module schedules print jobs according to a priority associated with the print job.

13. The system of claim 10 wherein said scheduling module schedules print jobs according to the match between the current configurable colorant set.

14. The system of claim 10 wherein said scheduling module schedules print jobs to wait until the printer is idle and further wherein the print job is sent to the idle printer together with a request to mount the configurable colorant required for the print job.

15. The system of claim 14 wherein said scheduling module schedules print jobs to wait for a predetermined minimum time before sending the print job to an idle printer.

16. The system of claim 10 wherein said scheduling module schedules print jobs to maximize the number of pages printed during a predetermined time interval.

17. The system of claim 10 wherein said scheduling module schedules print jobs to maximize profit during a predetermined time interval.

18. The system of claim 10 wherein said scheduling module gives higher priority to print jobs whose configurable colorant requirements match the current configurable colorant mounted on one of the plurality of printers.

19. A system for scheduling print jobs to a plurality of printers comprising:
a plurality of color printers, each color printer including one configurable colorant; and
a processor;
said processor being operatively connected to said plurality of printers;
said processor receiving status information from each printer, the status information including identification of the replaceable colorant currently installed in the printer and a current operating state of the printer;
said processor receiving print jobs, each print job containing requirements of the print job, a first requirement being information identifying replaceable colors required to print the job;
said processor maintaining a queue of print jobs, the queue being ordered according to the status information from the printers and the first requirement identifying replaceable colors required to print the job;
said processor submitting the jobs to the plurality of printers as each printer is available.
